(19) United States
(12) Patent Application Publication
(10) Pub. No.: US 2009/0183179 A1
(43) Pub. Date: Jul. 16, 2009

(54) User and business communication and discovery platform

(75) Inventors: Christopher Keith, New York, NY (US); Mark Kemna, White Plains, NY (US); Alexander Levin, New york, NY (US)

Correspondence Address: BRENDA POMERANCE;LAW OFFICE OF BRENDA POMERANCE, 310 West 52 Street, Suite 27B, NEW YORK, NY, 10019, US

(73) Assignee: Brilig LLC, New York, NY (US)

(21) Appl. No.: 12/319,793

(22) Filed: Jan. 12, 2009

Related U.S. Application Data
(60) Provisional application No. 61/021,020, filed on Jan. 14, 2008.

(51) Int. Cl. G06F 9/54

(52) U.S. Cl. 719/318

(57) ABSTRACT

A platform enables a business to learn about a user based on characteristics of the user and without knowing the identity of the user. The business specifies characteristics of users of interest to the business. When a platform user begins a session, a process representing the platform user interacts with the business's specification so that the business obtains the characteristics of the user without knowing the identity of the user. If the user's characteristics match the business's specification, then the platform takes an action specified by the business, such as sending an offer or advertisement to the user.

This application claims priority from U.S. provisional patent application Ser. No. 61/021,020, filed Jan. 14, 2008, which is incorporated by reference herein in its entirety. The present invention relates to a computer system used by businesses and consumers, and more particularly, is directed to software processes executing on the computer system that enable a business to learn about a user based on characteristics of the user and without knowing the identity of the user. The Internet still offers opportunities for improved ways to find things, such as products, information and other people.

### BACKGROUND OF THE INVENTION

Furthermore, providers of products, information and services, are always eager for improved ways to know potential customers. As an example, consider the advertising industry, which provides information to potential customers.

The advertising industry evolved from one-way media, such as print media (magazines, newspapers) and broadcast media (radio, television). There are many parties involved in creating an ad and presenting it to a user.

The Internet is becoming increasingly popular as an advertising destination. The infrastructure evolved from one-way advertising has been adapted to the Internet.

FIG. 1 is a chart showing the conventional relationship between parties involved in online advertising. It will be understood that variations of this configuration are possible. Many entities, not shown, provide tools or add-ons to the entities described below.

Marketer 10 is a source of products or services that wishes to make potential customers aware of its products or services.

Ad agency 12 is a business entity that works with marketer 10 to produce advertisements hopefully inducing potential customers to purchase or use the advertised products or services. Typically, ad agency 12 contracts to display the advertisements according to an ad campaign approved by marketer 10. Ad agency 12 is also referred to herein as a publisher.

Ad exchange 14 typically purchases ad space and sells the ad space to ad agency 12. Ad exchange 14 provides a pricing mechanism wherein the cost of displaying an ad depends on factors such as the volume of ad space purchased and how narrowly the target demographics are to be displayed. There is fierce price competition among ad exchanges.

Ad network 16 finds ad space on websites, and manages the ad space, that is, sells ad space to ad exchange 14.

Ad server 18 is a general purpose computer programmed to store ads and to serve ads to websites in response to a request for the ad. An owner of ad server 18 is sometimes referred to herein as a publisher.

Website 20 is a general purpose computer programmed to display information to a visitor to the website, and may also receive information from the visitor, perform transactions and so on. Website 20 is also referred to herein as a content server. An owner of website 20 is sometimes referred to herein as a publisher.

User 30 visits website 20 typically using a personal computer programmed with browser software, but may use another device such as a personal digital assistant or cellphone. User 30 is a potential customer for marketer 10. Demographic characteristics of user 30 are sometimes known from explicitly provided information, e.g., user 30 entered his address into a profile, or inferred from implicitly provided information, e.g., user 30's browsing history indicates an interest area.

However, since the Internet is a two-way medium, opportunities exist for an advertising infrastructure that is better adapted to this medium than the existing infrastructure.

### SUMMARY OF THE INVENTION

In accordance with an aspect of this invention, there is provided a method of reacting to a user based on characteristics of the user and without knowing the identity of the user. The characteristics of the user are obtained based on a session ID associated with the user and without knowing the identity of the user. The obtained characteristics are compared with at least one characteristic specified in at least one activity rule, each activity rule specifying at least one action. When the obtained characteristics match the specified characteristics in an activity rule, the action specified in the activity rule is performed.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a chart showing the conventional relationship between parties involved in online advertising;

FIG. 2 is a chart showing how the present invention is available to the parties involved in online advertising;

FIG. 3 is a block diagram showing the configuration of the present invention;

FIGS. 4A-4C are charts showing examples of valuegrams;

FIG. 5A-5C are flowcharts showing how an intelligent assistant answers questions about its user for creation of different valuegrams;

FIG. 6 is a flowchart showing how an intelligent assistant learns about its user;

FIG. 7 is a flowchart showing how an intelligent assistant determines an action it should take;

FIG. 8 is a flowchart showing operation of find like process 111;

FIG. 9 is a flowchart showing operation of people set generator process 113; and

FIG. 10 is a flowchart showing how dictionary 110 customizes information.

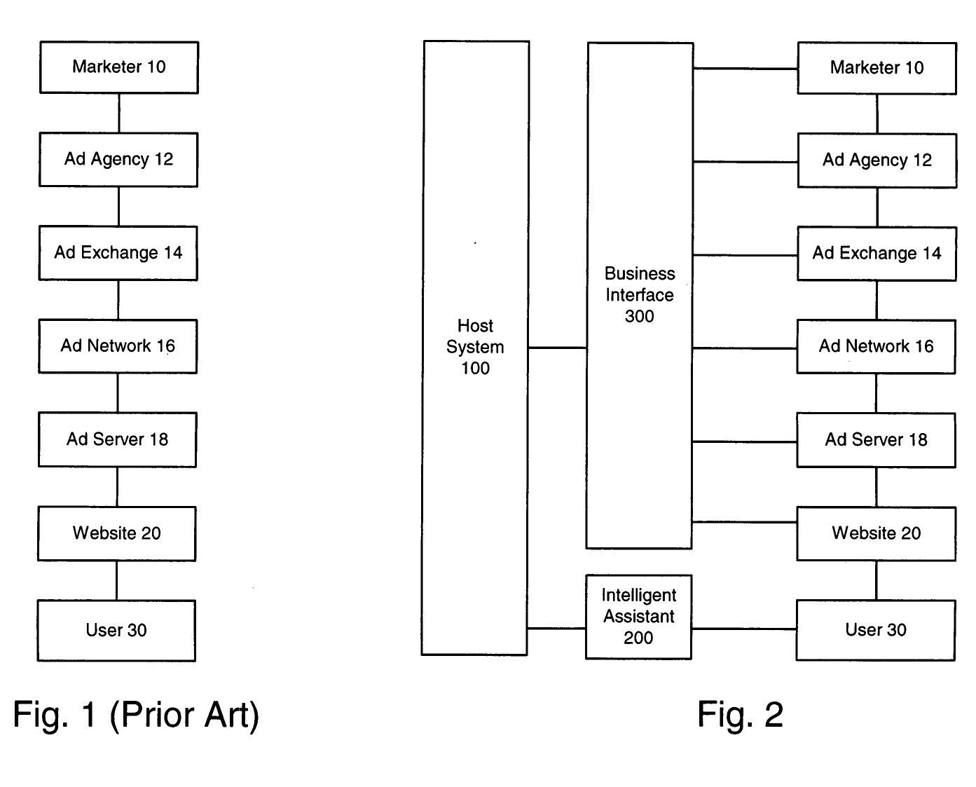

### DETAILED DESCRIPTION

A platform enables a business to learn about a user based on characteristics of the user and without knowing the identity of the user. The business specifies characteristics of users of interest to the business. When a platform user begins a session, a process representing the platform user interacts with the business's specification so that the business obtains the characteristics of the user without knowing the identity of the user. If the user's characteristics match the business's specification, then the platform takes an action specified by the business, such as sending an offer or advertisement to the user.

As used herein, the term “user” sometimes means a user of the services provided by host computer system 100 such as a software process, and sometimes means a visitor to a website.

FIG. 2 is a chart showing how the present invention is available to the parties involved in online advertising. It will be appreciated that the present invention is useful for applications other than online advertising; generally, in any application in which a user's characteristics affect how desirable that user is to another party, for example, mailing lists, dating services, membership organizations and so on.

In one embodiment, host 100 cooperates with intelligent assistant 200 and business interface 300 to deliver ads to a selected audience that is more receptive to ads as compared with a typical audience. Host 100 provides an infrastructure for matching the interests and characteristics of users with the information that marketers and publishers want to provide to users.

More specifically, intelligent assistant 200 passively and actively gathers information about its user, then subject to its user-specified privacy constraints, answers questions about its user and requests information on behalf of its user. Intelligent assistant 200 picks the most relevant information presented thereto, so its user receives only a desirably small quantity of information. That is, intelligent assistant 200 is adapted to influence and filter the information provided by marketers and publishers in accordance with the user's expressed wishes and behavior, improving the relevance of information presented to the user.

Business interface 300 is used by marketer 10, ad agency 12, ad exchange 14, ad network 16, ad server 18 and website 20, hereafter referred to as “the business community”. Business interface 300 enables a marketer (such as marketer 10) or publisher (such as website 20) to narrowly specify its desired audience for particular ads, and to tune (personalize) their material in accordance with the characteristics of each user. Advertising conducted using host 100 is delivered only to users having desired characteristics and who have an interest in receiving such advertising as determined by their intelligent assistant 200. Host 100 enables advertisers to bid against each other for the right to show their ad to a particular user, on a user-by-user basis.

For example, when a user visits a website, the user's intelligent assistant provides characteristics about the user in accordance with the user's privacy settings and interests that the user has, as explicitly provided by the user and as implicitly evidenced by the user's behavior; these characteristics and interests are then bid upon by advertisers. In many cases, the highest bid determines the ad to be shown to the user, but in other cases, generally with user consent, more than one ad is provided to the user.

An advantage of having a layer of processing between host system 100 and each of user 30 and the business community is that the identity of each user 30 can be more easily secured. That is, the present configuration enables the business community to know the characteristics of user 30 without knowing the identity of user 30, making user 30 much more valuable to portions of the business community than if his or her characteristics were unknown.

A conventional service, Facebook Open Connect, provides a user's profile information to other websites without anonymity.

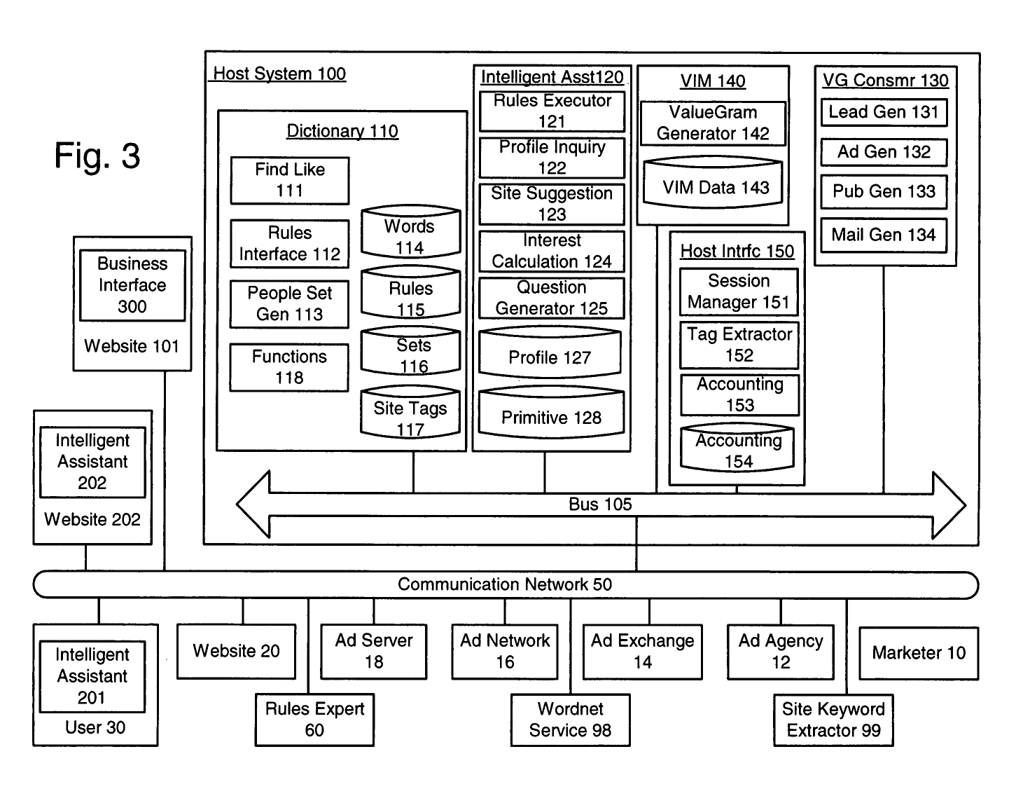

FIG. 3 is a block diagram showing the configuration of the present invention.

Communication network 50 enables transmission of data between entities, and may include wireline and wireless links coupled by computers for transmitting packets of information, such as the Internet.

As shown in FIG. 3A, all entities communicate with each other via network 50. In some embodiments, selected entities additionally and/or alternatively have private communication paths therebetween. Entities include marketer 10, ad agency 12, ad exchange 14, ad network 16, ad server 18, website 20, user 30, rules expert 60, wordnet service 98, site keyword extractor 99, host 100, and websites 101, 202. Entities are represented by a general purpose computer programmed according to the present invention and having suitable communication facilities. An entity's general purpose computer may be, e.g., a personal computer, a personal digital assistant, a server computer with a client terminal, several computers sharing a high speed bus and storage media, and so on. Software on an entity's general-purpose computer includes an operating system and an internet browser, as well as software according to the present invention, described below.

Host 100 is adapted to execute dictionary process 110, intelligent assistant process 120, valuegram consumer process 130, visitor information manager (VIM) process 140 and host interface process 150. Each of 110, 120, 130, 140, 150 is one or more software processes executing on one or more processors with suitable memory and storage, coupled to high speed bus 105, which is in turn coupled via firewall software (not shown) to network 50.

Intelligent assistant 200 of FIG. 2 is configured in FIG. 3A as three parts: intelligent assistant (IA) 201 associated with an access device for user 30 such as a personal computer, intelligent assistant 202 associated with website 202, and intelligent assistant 120 associated with host 100. There is one instance of each of intelligent assistants 201 and 120 for each user 30. There are many instances of user 30.

Intelligent assistant (IA) 201 may be embodied as a software browser toolbar. IA 201 communicates with host 100, sometimes via IA 202. IA 201 is generally downloaded to user 30 from website 202, but may be provided in other ways: as part of a third-party browser toolbar, downloaded from website 20 and so on. When user 30 activates his or her browser, this is considered the start of a session. IA 201 generates a request for session ID, such as a combination of its unique ID, a timestamp and a flag indicating this is a session ID, and sends the request for session ID to host interface 150. Session manager 151 of host interface 150 sends a session ID to IA 201. When user 30 takes other actions, IA 201 similarly notifies host interface 150, for example, when user 30 enters a website address to his or her browser, IA 201 similarly obtains a website session ID, such as a combination of its unique ID, a timestamp, a flag indicating this is a website session ID and the website address, from host interface 150. As another example, a webpage ad received by user 30 in response to a valuegram (described below) includes an identifier that is recognized by IA 201, and IA 201 reports receipt of the ad to IA 120 as an event for storage in primitive database 128. Further, IA 201 reports actions taken by user 30 to IA 120 for storage in primitive database 128. Additionally, IA 201 enables user 30 to conveniently interact with IA 202.

Intelligent assistant 202 allows user 30 to interact with dictionary 110 of host 100, to conduct transactions such as online shopping, and to view and update their user profile in profile database 127, such as changing their current level of interest in products and other terms. Generally, IA 202 has screen templates that are populated with information from dictionary 110 and profile database 127 in response to requests from user 30, and the thus-created screens are delivered to user 30 for display in a browser window.

Business interface 300 is associated with website 101. More specifically, business interface 300 operates as website software process according to a request/response protocol on hardware and communications facilities referred to as website 101. There are one or more instances of website 101. The instances of business interface 300 executing at the various websites 101 need not be identical. Business interface 300 is used by the business community (marketer 10, ad agency 12, ad exchange 14, ad network 16, ad server 18 and website 20) and rules experts 60; the users of business interface 300 are assumed to be executing browser software that interacts with business interface 300. Functions provided by business interface 300 to the business community and rules experts 60 include:
create, edit and store in rules database 115, dictionary labeling rules so that a user with certain characteristics should be labeled accordingly. Periodically, each user's intelligent assistant checks for new or updated rules and adjusts the labeling for its user profile accordingly;
create, edit and store in VIM database 143, valuegram creation rules, so that when users having predefined labels are active with regard to network 50, actions automatically occur. The actions include one or more of providing information, such as an ad or coupon, to the user, and providing notice to a website that a user having predefined labels is engaged with the website, but not the user's identity;
create, edit and store in dictionary 110, questions, so that when question generator 125 executes, users 30 are prompted to provide desired information about themselves;
create, edit and store in VIM database 143, account information such as passwords, contact information and billing information;
view, create and edit words in words database 114;
view, create and edit sets (also referred to as collections) in sets database 116; and
interact with accounting and audit trail information in accounting database 154, such as to request periodic activity reports, examine billing statements, and so on.

As used herein and in the claims, a rule means a statement of the form IF (one or more trigger conditions) THEN (one or more actions to perform). Trigger conditions typically are logical tests that evaluate to a true or false condition, and when true, the specified actions are to occur. Actions may include creating information and/or assigning values in host 100.

Users and the business community, referred to herein as “the public” augment dictionary 110 by adding words, sets and rules, as described below. Over time, dictionary 110 grows to represent more information about the world, and each IA 120 becomes more knowledgeable about its user based on dictionary 110, the information explicitly specified by the user, and the information gathered about the user's actions, sometimes referred to as passive user information. Accordingly, over time, host 100 becomes more useful for user 30, and host 100 becomes more useful to the business community as selected target audiences can be reached more easily.

Rules expert 60 creates database queries, that is combinations of database primitive elements and operators, and may set privacy levels and usage fees for using each query (rules). Via business interface 300, rules expert 50 uses rules interface process 112 of dictionary 110 to create database queries. For example, a marketer with an advertising campaign aimed at a particular audience creates a database query to describe the target audience. The rules are executed by rules executor process 121 of intelligent assistant 120.

Wordnet service 98 is a third party provider of a thesaurus like function. Wordnet service 98 is used to augment words database 114 of dictionary 110. In a typical scenario, user 30 provides a search word to website 20, and intelligent assistant 201 sends a copy of the search word to intelligent assistant 202 that finds the word is not in words database 114, and so IA 202 queries wordnet service 98 for synonyms.

Site keyword extractor 99 can be a third party, lacking access to site tags database 117, that receives a webpage address, that is, a universal resource locator (URL) and timestamp, takes a snapshot of the web page, and returns the keywords for the webpage to tag extractor process 152. Keywords are obtained from the metadata created especially for the website that contains keywords in a metadata field for search engines, and/or from analysis of the contents of a webpage. An example of a keyword extraction program is Metatag-Admin, which can be downloaded from http://sourceforge.net/projects/metatag-admin/. An example of a third party website that analyzes keywords on a webpage is Ranks at http://www.ranks.nl/.

Dictionary 110 includes find like process 111, rules interface 112, people set generator process 113, words database 114, rules database 115, sets database 116, site tags database 117, and functions 118. Dictionary 110 is a group of databases providing information for users of host 100. Initially, the databases are populated with default information. The databases are augmented by the public. Dictionary 110 is a wiki-type database comprised of ways of categorizing products, services, people, words, websites, and other entities, and descriptors to define them. Dictionary 110 is also a mechanism for discovering products and information via various functions that can be applied to its databases.

Find like process 111 sorts through dictionary 110, particularly words database 114, and creates new collections in response to user requests. By doing this, it is able to find words which are “like” other words because they are contained in a human made collection and thus have a relationship to each other.

For example, user 30 may identify bee repellant and EpiPens as products which she is interested in. Via a screen interface provided by IA 202, user 30 can then use find like process 111 to find collections of objects like these, which she can then purchase. In some embodiments, one or more of the creators of the collections viewed prior to the purchase receive a fee or other form of compensation.

Rules interface 112 is used by rules experts 60 to define or redefine a rules attribute. Rules interface 112 allows rules experts 60 to view aggregate user primitive data and combine them in any combinations they desire to form a complex SQL-like queries, and save the queries in rules database 115. Others wishing to modify dictionary 110 also use rules interface 112, such as the public.

People set generator process 113 creates sets of users by analyzing how many interests and demographics they have in common, then saves these as new people sets in sets database 116. In addition, people set generator process 113 is adapted to look up saved people sets and request interest and history information from the IAs for the users in the saved people sets, to find words and sets which other similar users have used or are interested in.

People set generator 113 supports a “People Like Me” function enabling user 30 to see aggregate anonymous information about the actions performed by people within a set that user 30 is a member of. A user can see how similar users have acted in response to information that the instant user is considering. For example, when viewing a product set, a user can apply the “People Like Me” function and learn that 25% of people in the user's people set have purchased a product in the product set. This may encourage the user to obtain rating information for this particular product and ultimately to purchase it.

Words database 114 is essentially a synonym list and associated questions to ask a user to determine if the user is interested in this item. Asking of the questions is discussed below with regard to question generator 125. Words database 114 is a folksonomy, that is, is a usage-derived association of words. Words database is helpful to user 30 when he or she is searching for something, and is helpful to the business community when trying to find out if a user has an interest in something. Words database 114 is created and updated via an interface in dictionary 110 (not shown).

A user can tag objects—words, people, products, websites, sets, rules—in system 100 with Words. System 100 creates and stores a record of the tag, object of the tag, and user who did the tagging. This information can be used to track the usage of any particular word and see which objects have been tagged with that word. It can also be used to see which people collections are using which words for tagging. Thus, a user is able to use IA 202 to see that the tag “That's Hot” is being used by 95% of Beverly Hills Teenage Girls.

Publishers can provide their own keywords and tags to dictionary 110 via host interface 150. This information can be different per user 30 if the publisher has knowledge of the user, either from receiving a valuegram, or from another methodology. If the tags provided are later used to effect a transaction, the publisher may receive a percentage of the transaction amount. For example, assume that user 30 reads an article on bee stings on website 20. The tags “bee sting allergy” and “small child” are recorded in user 30's primitive database 128 and in site tags database 117. If user 30 later receives a coupon because of the tag provided by website 20, then in some embodiments, website 20 receives a percentage of the fee paid to deliver the coupon to user 30.

Rules database 115 contains all terms (predefined database queries, also referred to as rules) that can describe user 30, and applicable operators that can be used with the rules terms. The rules terms represent demographic and other information. Rules terms are defined by rules experts 60 and the public using rules interface 112. A rules term can be for public use, or for private use, accessible to only a selected party. Fields of rules database 115 may include ID; Name; Short and Long Descriptions; Datatype—Boolean, Text List, Number Range, Date; Security—Public, Private, Group; Owner (Author)—link to owner table; Price for Using the Rule; Definition—text; RulesProcessID—link to information about how to use the Rule; and Popularity/usage metric. An example of a rule definition in rules database 115 is:

| | |
|---|---|
| IF | (user-gender = female) and |
| | (user-age >12 and user-age < 20) |
| | (user-address-zipcode = 90210) |

THEN user = “Beverly Hills teenage girl”

Rules can operate on objects, users, or collections. The output of a rule is a collection. A collection can be only one object in size. If a user runs a particular rule, host 100 may ask for additional information which the rule requires in order to run effectively. All information which the user provides is saved to their primitive database 128.

Sets database 116 is for storing sets, also referred to as “collections”, created by the public, that is, users of system 100, and hierarchies that serve as indices enabling a set to be located. A collection is a group of items. The items can be words, products (a specialized type of word), people, websites, rules, or other collections. Using IA 202, users are able to search for and find different types of collections.

Sets database 116 is created and updated via an interface in dictionary 110 (not shown). Fields of sets database 116 include:

ID

Author

Product Hierarchy

Rules Info—link to information about how to use the set

Popularity/usage metric

For example, a particular product provider such as marketer 10, creates sets of information describing its products. A set for a product may include information about the history and use of the product, reviews of the product, vendors, price comparisons, related products and services, and immediate purchase capability via one of the vendors. For sets made by user 30, the business community may arrange for a referral fee if a purchase occurs as a result of someone using the set.

Amazon offers a Listmania service, wherein users of the Amazon website can create lists of items. If someone is browsing the Amazon website, specifically, viewing a product description page for a product that is included on a list of items, then a link to the list is provided on the product description page. For example, a user may create a list of their favorite 40 books, and this is displayed to anyone browsing the book description page, so that the person browsing may use the list to suggest other books of interest to the browser.

In one embodiment of dictionary 110, user 30 employs a screen-based interface of IA 202 to access sets database 116 as follows.

First, IA 202 displays a screen offering action choices to user 30. User 30 selects “view sets relating to” and enters the keywords “baby strollers”.

Next, IA 202 retrieves hierarchy information from sets database 116 and presents user 30 with an ordered set of information to choose from, e.g., Baby>Strollers>Jogging Strollers, Walking Strollers. Each item has an associated calculated interest and threshold interest, both interests being determined by host 100 based on the profile information for user 30 in profile database 127. IA 202 also provides a list of actions that the user can select relating to their chosen term (e.g., “Jogging Strollers”), such as {Learn, Reviews, Shop, News, Talk, Save}.

Assume that user 30 selects “Shop”. IA 202 next provides a selection of stores to shop from. Assume that the user selects a particular store.

Next, the selected store, such as website 20, provides a webpage to the user enabling the user to purchase a jogging stroller. In other embodiments, IA 202 retrieves another set from dictionary 110 indicating which jogging strollers are available at the selected store along with helpful information such as price, delivery cost, delivery time, calculated interest, links to product descriptive information and so on.

Another usage of people sets is that a user can find out which websites, products, sets, or other types of objects that users in their particular people set have been interested in recently. For example, a Beverly Hills Teenage Girl uses the IA 202 interface to search for products which other Beverly Hills Teenage Girls have bought within the last week.

Another usage of people sets is that if a user gives permission, a user is able to send and receive messages to other users within their people sets. Thus, a Beverly Hills Teenage Girl can use system 100 to communicate with other Beverly Hills Teenage Girls.

Site tags database 117 contains information relating to webpages and tags derived from keywords for webpages. As used herein, a “tag” is a word in words database 114. Site tags database 117 includes scoring information provided by the public on both websites and their keywords, to enable determination by intelligent assistant 120 as to how accurate the webpage is in predicting user interest. Site tags database 117 is used by tag extractor 152 of host interface 150, as described below. Site tags database 117 includes a webpage (URL) table of all URLs known to host 100 and their score; webpage (URL) data including the URL, a keyword, and timestamps of when the URL was first and last stored in site tags database 117; keyword mapping data including keywords and their relevancy values; and keyword frequency data indicating how popular a keyword is.

Functions 118 are processes that are time-driven and/or event-driven to process the data in dictionary 110. Functions 118 include:
Filter By Attribute Process—enables user 30 to filter search results by attributes (tags) associated with elements of sets. For example, in response to a search for bee repellent, IA 20 returns various collections to user 30, who then filters by the attribute “non-scented” to retain only sets having elements with a “non-scented” attribute.

Intelligent assistant 120 includes rules executor process 121, profile inquiry process 122, site suggestion process 123, interest calculation process 124, question generator process 125, profile database 127 and primitive database 128.

Intelligent assistant (IA) 120 serves to answer questions about a user without disclosing the user's identity, and to provide various services to processes in host 100 and intelligent assistants 201, 202, and business interface 300. There is an instance of IA 120 for each user 30. IA 201 obtains information about a user by asking the user questions, and by monitoring the user's activity. Each user can control (adjust or turn off) functions of their IA 120 to obtain as much privacy as desired. Intelligent assistant 120 also converts data in primitive database 128 to data in profile database 127. Dictionary 110 also converts data in primitive database 128 to data in profile database 127.

Rules executor process 121 periodically checks rules database 115 for new or modified rules. In some embodiments, an event triggers execution of rules executor process 121. Rules executor process 121 executes the new or modified rule against its version of user primitive database 128, and when appropriate, updates user profile 127 with information resulting from executing the new or updated rule. Occasionally, rules executor process 121 verifies the calculated data in user profile 127 so that changes in the user's characteristics can modify whether certain labels (results of rules execution) still apply to the user. For example, when a user's age or address changes, a formerly correct label of “Beverly Hills teenage girl” may no longer be correct.

Profile inquiry process 122 answers questions about a user's characteristics and labels, such as user 30, from other processes, such as valuegram generator processes 142, by first determining whether the user has allowed the requested information to be used in an answer, and then, if allowed, looking up and returning the actual answer. Generally, profile inquiry process 122 retrieves information from profile database 127.

Site suggestion process 123 runs at predetermined times or intervals to find webpages of possible interest to user 30, based on the following factors:
Percentage match between user profile and site tags
Popularity of a webpage—both as a whole and for the user's profile type
Whether user seen the page previously
Is site publisher known to host 100
Whether site publisher paid for their site to have higher priority
Tags received during this session
   These webpages are provided to user 30 in accordance with a schedule controlled by user 30. For example, by appropriately adjusting a value in their profile, user 30 can accept information about a new webpage once per day, once per week, once per session, as such pages become known to process 123 and have a likely interest greater than a predetermined value, and so on.

Interest calculation process 124 calculates the interest of user 30 in each word of words database 114 and in each set of sets database 116 according to a predefined procedure that can be updated by host 100 or by user 30. As an example of a default procedure, process 124 reviews primitive database 128 to see what user 30 has done, and assigns one unit of interest to any word or set viewed by user 30 within the last three months, with each viewing adding another unit of interest. User 30 can explicitly set his or her interest level in various words or sets.

Question generator process 125 serves to generate questions for presentation to a user, so as to learn more about a user. When a user first creates his or her profile on system 100, question generator 125 provides a default set of questions. The user can subsequently initiate a question asking session through IA 201. Question generator 125 also has rules for when it generates additional questions for a user and presents the questions to the user, such as when the user becomes active on a new topic, and in response to information desired by the business community as stored in the questions associated with words database 115 and sets database 116 and after a specified (by the user) interval since the last question. The factors that determine which questions are initiated by question generator 125 and in which order include (a) the likelihood of a user answering the question based on (i) how many times they have seen it, and how sure host 100 is to already knowing the answer, i.e., minimum threshold of interest (a value maintained in profile database 127); (b) the value of the question as set by the question's author; (c) the content of the information viewed recently by user 30; and (d) whether user 30 is doing something that permits a question to be asked.

One way that user 30 can add information to his/her profile database 127 is via a training session. In this session, question generator 125 presents a series of questions to a user and the user provides answers. A user can tag, rate, or comment on any website or object within system 100. The ratings can be selected from “Thumbs Up”, “Thumbs Down”, and “Never Show Me This Again”.

Profile database 127 is a collection of information about a user, some of which is provided explicitly by the user, and the rest of which is calculated by host 100 in response to the user's activity as recorded in primitive database 128, labeling rules in rules database 115, question stored in VIM database 143, and rules included in intelligent assistant 120. Profile database 127 includes an attribute table, a demographics table, and an account settings table. The attribute table includes the results of calculations by host 100 regarding user 30, for example, records including identification of the rule that motivated the calculation, the calculated value, any relevant user set value, a timestamp, and an interest level enabling the user to adjust his or her interest in receiving information relating to the calculated information. The demographics table includes descriptive information such as gender, job, birthdate and so on. The account settings table includes username, password, billing information, email address, and so on.

Primitive database 128 is a collection of tables containing raw (unprocessed) data relating to a user's actions: the browsing history table, the VIM transaction table, the search keyword table, the VIM questions table, and the user choice table. These tables are populated by various methods, including observing actions (navigation and information provision) taken by the user, recording information presented to the user by host 100, recording information provided by the user in response to questions, and importing data from external websites such as a profile in a social network website. Data describing user actions and events experienced by users is located in primitive database 128 along with statistics about how common each term (type of data) is in primitive database 128.

A user is able to tag, rate, or comment on any object in the system. This information is stored both in the user's primitive database 128 and with the object in dictionary 110. Tags and ratings can be used by rules executor 121 and interest calculation process 124.

A valuegram is an ordered collection of information to be delivered to a destination in response to activity by user 30. Three types of valuegrams are described herein; other types are also contemplated.

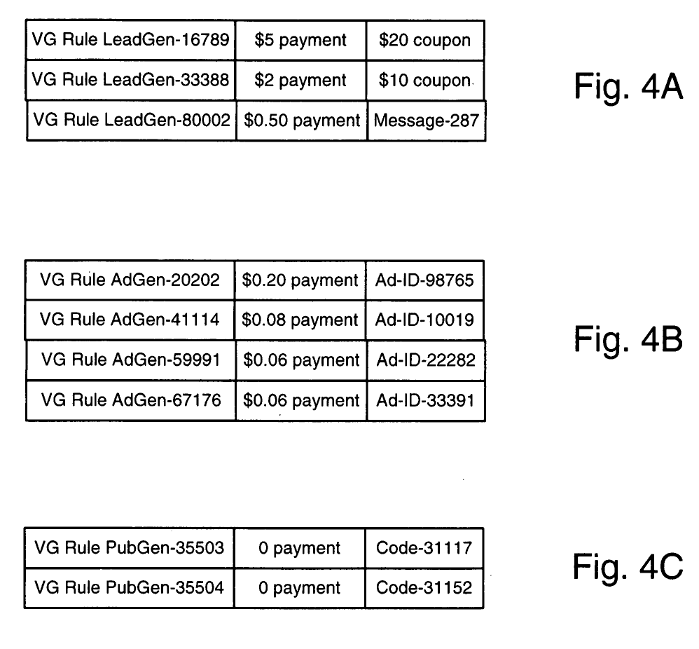

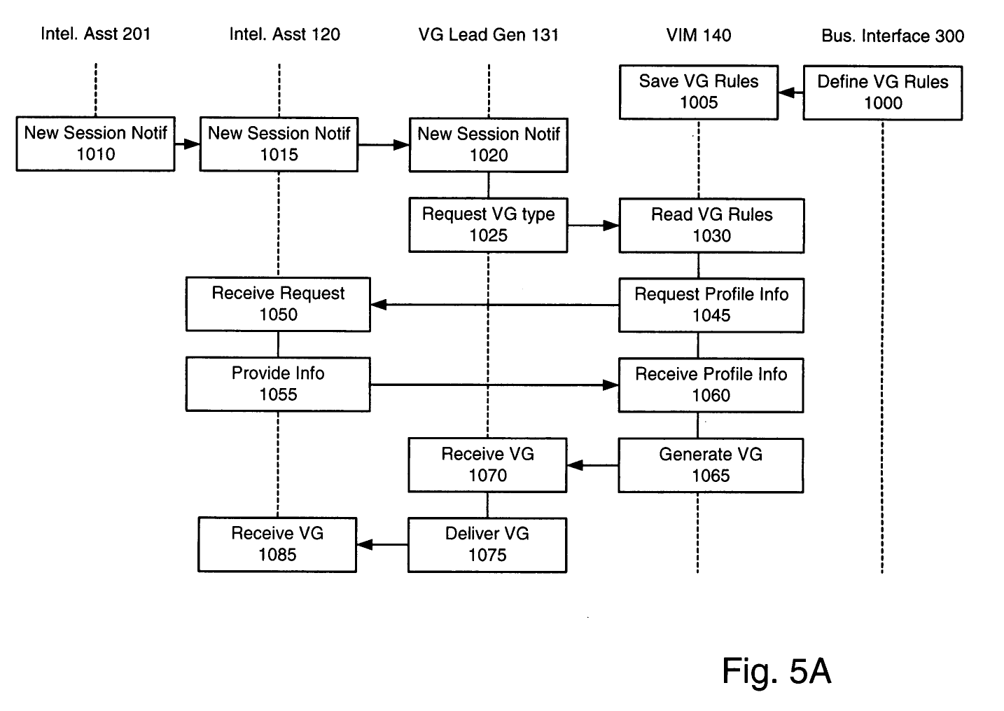

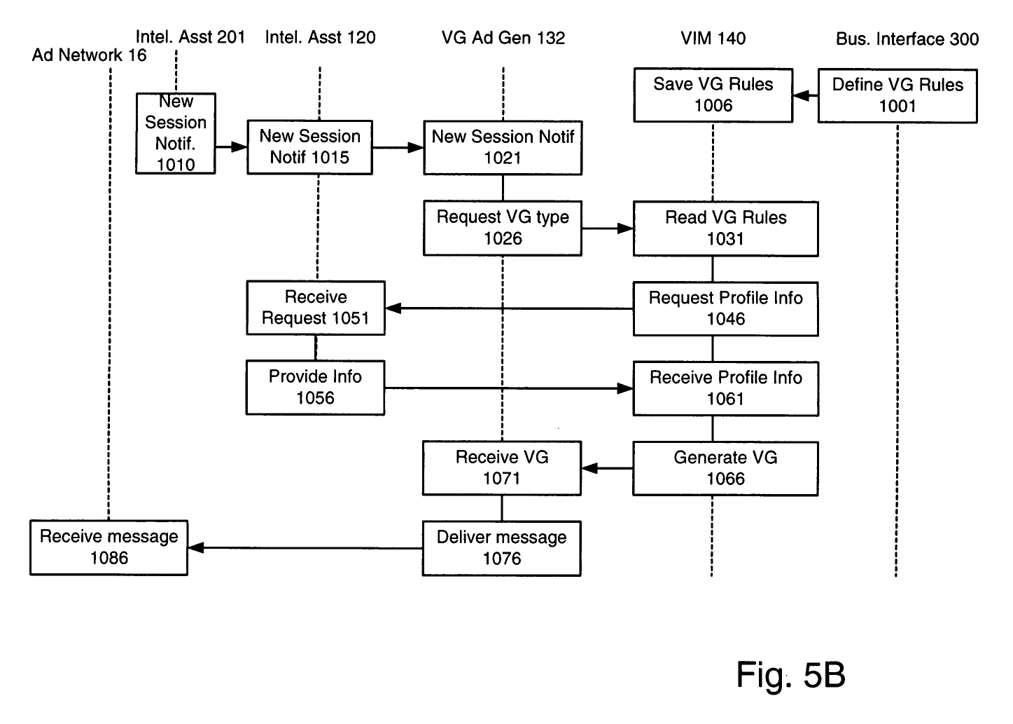

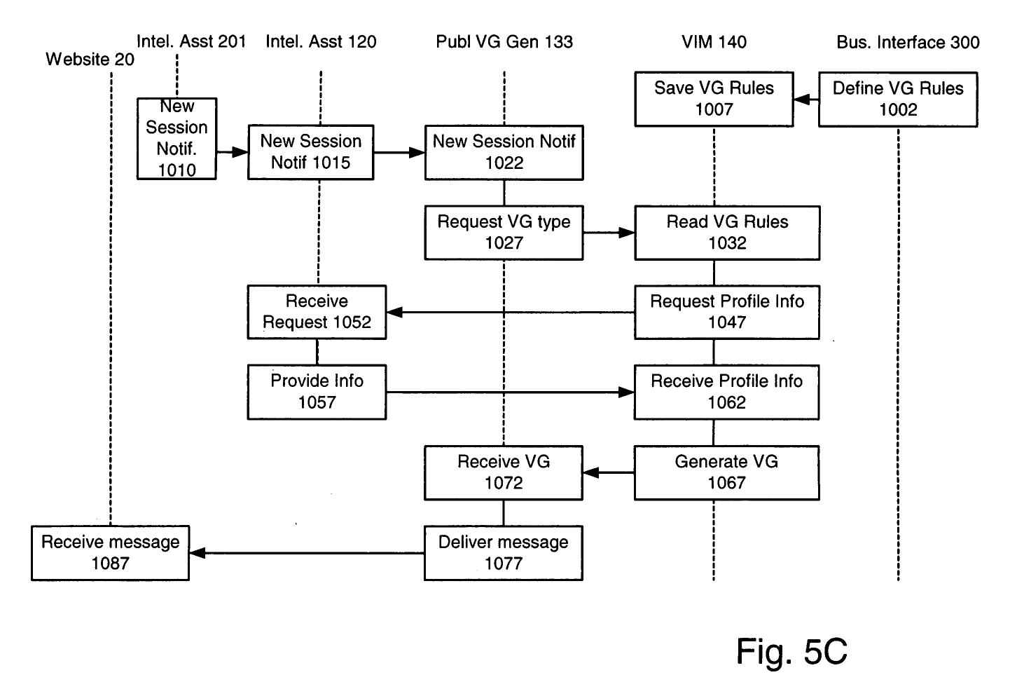

FIG. 4A is a chart showing a lead generation valuegram, discussed in connection with FIG. 5A. Briefly, when user 30 begins a session of using their browser and/or upon other specified events, appropriate ones of lead generation processes 131 are notified, and processes 131 request that valuegram generator process 142 generate a leads valuegram consisting of offers such as coupons or messages that the business community wishes to provide to user 30 based on his or her characteristics. Based on default rules and expressed preferences of user 30, one or more of these offers are then delivered directly to user 30. FIG. 4A shows a valuegram with three offers: the first offer results from a valuegram lead generation rule having ID 16789, and indicates that the author of the rule will pay $5 to deliver the offer to user 30, and that the offer is a $20 coupon; the second offer results from a valuegram lead generation rule having ID 33388, and indicates that the author of the rule will pay $2 to deliver the offer to user 30, and that the offer is a $10 coupon; and the third offer results from a valuegram lead generation rule having ID 80002, and indicates that the author of the rule will pay $0.50 to deliver the offer to user 30, and that the offer data pointed to by message-287, which can be text or multimedia information, and is to be delivered to user 30 in a specified manner, such as by a pop-up window in the user's browser generated by IA 201, an e-mail message to user 30 and so on.

FIG. 4B is a chart showing an ad generation valuegram, discussed in connection with FIG. 5B. Briefly, when user 30 begins a session of using their browser and/or upon other specified events, appropriate ones of ad generation processes 132 are notified, and processes 132 request that valuegram generator process 142 generate an ads valuegram consisting of ads that the business community wishes to provide to user 30 based on his or her characteristics. Based on default rules and expressed preferences of user 30, one or more of these ads are then delivered by an appropriate member of the business community to user 30. It will be recalled that offers from lead generation are delivered directly to user 30, in contrast to ads, which are delivered by a member of the business community to user 30. FIG. 4B shows a valuegram with four ads: the first ad results from a valuegram ad generation rule having ID 20202, and indicates that the author of the rule will pay $0.20 to deliver the ad to user 30, and that the ad is indicated by ad-id-98765 (an ad-id has meaning to the member of the business community that is supposed to deliver the ad); the second ad results from a valuegram ad generation rule having ID 41114, and indicates that the author of the rule will pay $0.08 to deliver the ad to user 30, and that the ad is indicated by ad-id-10019; the third ad results from a valuegram ad generation rule having ID 59991, and indicates that the author of the rule will pay $0.06 to deliver the ad to user 30, and that the ad is indicated by ad-id-22282; and the fourth ad results from a valuegram ad generation rule having ID 67176, and indicates that the author of the rule will pay $0.06 to deliver the ad to user 30, and that the ad is indicated by ad-id-33391.

FIG. 4C is a chart showing a publisher valuegram, discussed in connection with FIG. 5C. Briefly, when user 30 visits a publisher such as website 20, publisher valuegram process 133 is notified, and requests that valuegram generator process 142 generate a publisher valuegram consisting of a code that the publisher wants to receive upon arrival of a website visitor having a predetermined group of characteristics. Generally, the publisher uses the code to customize how its website appears to user 30, for example, dynamically created parts of its webpages will reflect the characteristics of user 30. As another example, prices shown on the publisher's website may reflect whether user 30 is a member of the publisher's website. FIG. 4C shows a valuegram with two publisher codes: the first code results from a valuegram publisher rule having ID 35503, and indicates that code 31117 should be delivered to the publisher's website upon the arrival of user 30 at the publisher's website; and the second code results from a valuegram publisher rule having ID 35504, and indicates that code 31152 should be delivered to the publisher's website upon the arrival of user 30 at the publisher's website.

People are automatically assigned to different people sets via rules executor 121 and interest calculation process 124 based upon what information is in their primitive database 128. These people sets are then used by system 100 to determine a user's interest level in other objects. For example, if user 30 is in the collection titled Mothers With Small Children and 35% of its members indicated that they are interested in bee repellent, then there is a 35% chance that user 30 is interested in bee repellent.

Valuegram (VG) consumer processes 130 includes lead generator 131, ad generator 132, publisher VG generator 133, and mail generator 134. Other types of valuegrams are contemplated in response to the desires of members of the business community to interact with user 30. VG consumer processes 130 know only a user's session ID and selected permitted profile information for the user, thereby ensuring anonymity and a desired level of privacy for the user.

Valuegram consumer processes 130 control the creation and delivery of valuegrams. An external party, such as marketer 10 or ad agency 12, creates a VG consumer process 130 that typically registers with host interface 150 to receive a notification when user 30 performs an activity such as starting a browser session or going to a website (URL). Alternatively, a VG consumer process may execute at predetermined times, or be triggered by an event. VG consumer process 130 typically requests a particular type of valuegram from VG generator process 142, which creates the valuegram and delivers the valuegram to an appropriate destination according to its rules.

Lead generation process 131 causes generation of information delivered directly to user 30. More specifically, lead generation process 131 registers with host interface 150 to receive notifications of when a user starts a new browser session. In response to each notice, lead generation process 131 requests a lead generation valuegram as shown in FIG. 4A, as described in detail below with regard to FIG. 5A.

Ad generation process 132 causes instructions for one or more ads to be delivered to user 30 from a member of the business community. More specifically, ad generation process 132 registers with host interface 150 to receive notifications of when a user starts a new browser session, visits a website, or other events. In response to each notice, ad generation process 132 requests an ad generation valuegram as shown in FIG. 4B, as described in detail below with regard to FIG. 5B.

Publisher valuegram generator process 133 causes one or more codes to be delivered to a publisher when user 30 visits the publisher's website. More specifically, publisher valuegram generator process 133 registers with host interface 150 to receive notifications of when user 30 arrives at the publisher's website such as website 20. In response to each notice, publisher valuegram generator process 133 requests a publisher valuegram as shown in FIG. 4C, as described in detail below with regard to FIG. 5C.

Mail generator process 134 is adapted to send messages to users. These messages can be delivered via IA 201, IA 202, or an external mechanism such as email. In one embodiment, a user can configure IA 120 to deliver a periodic email containing offers that match the user's interests; mail generator 134 participates in aggregating offers into an email.

Visitor information manager (VIM) process 140 includes valuegram (VG) generator process 142 and VIM database 153.

VG process 142 is adapted to relay request for information (questions) from VG consumer processes 130 to IAs 120, to collect and sort the information returned from IAs 120 into a valuegram, and to deliver the valuegram to appropriate destination(s). Generally, the sorting is to arrange the parts of the valuegram according to how much revenue each part represents. The valuegram creation and delivery mechanism enables the business community to reach people having desired characteristics while maintaining the privacy of the people's identity, and restricting the reach to what the people are comfortable with. More specifically, when VG generator process 142 receives a valuegram generation request, process 142 retrieves pertinent VG generation rules from VIM database 143, and in accordance with the retrieved rules, requests information specified in the rules from profile inquiry process 122 of IA 120. VG generator process 142 decides that a rule is pertinent when its trigger conditions match the information in the VG creation request from VG consumer process 130.

VIM database 153 contains valuegram generation rules used by VG generator process 142, and author information for authors (owners) of the valuegram generation rules and questions. The valuegram generation rules and questions are provided via business interface 300 from members of the business community, that is, from marketer 10, ad agency 12, ad exchange 14, ad network 16, ad server 18 and website owner (publisher) 20. A valuegram generation rule has a unique identifier, an identifier as to the type of valuegram it relates to—such as lead generation, ad generation or publisher, shown in FIGS. 4A-4C, respectively—a rule of the form IF (trigger conditions) THEN (actions), and optionally a monetary value that the rule author is willing to pay for accomplishing the actions specified in the rule. Author information includes identifier, payment means such as credit card that is authorized to be charged, corporate affiliation, contact information, login name for business interface 300 and so on.

Host interface process 150 includes session manager process 151, tag extractor process 152, accounting process 153 and accounting database 154.

Host interface process 150 serves as a traffic director and auditor for processes executing on host 100, and as a gateway to host 100 for external entities.

Session manager process 151 maintains a table showing the session IDs of currently active users and their user IDs. Keeping this information in process 151 ensures that only anonymous information about users is available to the business community. Session manager process 151 also maintains a table of which VG consumer processes 130 have registered with process 151 to receive notifications of which types of events, so that when an event occurs, session manager process 151 notifies appropriate ones of VG consumer processes 130.

Tag extractor process 152 is operative in several ways.

As user 30 visits a new webpage, tag extractor 152 records the webpage address in site tags database 117 along with tags describing the webpage, a keyword freshness flag, and a predictability quality score (PQS).

Keywords for the webpage are obtained from site keyword extractor 99. Tag extractor 152 maps the keywords for the webpage to known terms (words) in dictionary 110. A “tag” is a word in dictionary 110.

The PQS represents how well the webpage predicts the interests of the user viewing the webpage. Tag extractor 152 determines the PQS according to a predefined procedure. An example of a procedure for determining the PQS is:

```
If (webpage does not change frequently) and (keywords do not change
frequently)
      then webpage PQS = HIGH;
If (webpage changes frequently) and (keywords do not change frequently)
      then webpage PQS = MEDIUM;
If (webpage changes frequently) and (keywords change frequently)
      then webpage PQS = LOW.
```

An example of a webpage with a high PQS is one that has static text, such as an article about allergies. An example of a webpage with a medium PQS is a celebrity fan webpage; another example is a products page at a shopping site. An example of a webpage with a low PQS is the homepage for a news site.

In response to a tags request for a webpage from interest calculation process 124, tag extractor process 152 looks up the tags for the webpage from site tags database 117, and when the keyword freshness flag indicates that they keywords are not fresh, tag extractor 152 requests fresh keywords from site keyword extractor 99, and tag extractor 152 maps the newly obtained keywords to tags.

Accounting process 153 updates accounting database 154 for billing and audit trail purposes.

Accounting database 154 keeps track of all usage and monetary transactions generated by host 100, intelligent assistant 200 and business interface 300.

Operation of the system depicted in FIG. 3 will now be discussed in connection with a sample use case. The sample use case is first described at a high level, and then described in connection with the operation of host 100.

Assume that rules database 115 contains the rules shown in Table 1, defining the terms “Epipen buyer” and “Mother of a Small Child”. An Epipen is an autoinjector filled with single dose of epinephrine, requires a prescription to purchase in the U.S, and has a shelf life of about 20 months. An autoinjector is a spring-driven syringe. Epinephrine is an antidote for those allergic to bee stings.

TABLE 1

| Rule ID: | Label Rule-88123 |
|---|---|
| Rule Author: | Expert 60 |
| Rule Label: | “Epipen buyer” |
| Label values: | Is-not, Is |
| Definition: | If (user purchased “epinephrine autoinjector” |
| | within 20 months) |
| | then (user IS) |
| | else (user Is-not) |
| Label use price: | $0.10 |
| Rule ID: | Label Rule-00125 |
| Rule Author: | Expert 60 |
| Rule Label: | “Mother of a Small Child” |
| Label values: | Is-not, Is |
| Definition: | If ((user IS female) and (user HAS child) and |
| | (child age IS (>3 and <8))) |
| | then (user IS) |
| | else (user Is-not) |
| Label use price: | $0.001 |

For the sample use case, assume Debbie, an instance of user 30, is a mother of a 4-year old boy, Brad, who is allergic to bee stings. Debbie has configured her user profile at host 100 to get a daily suggestion of a new website that might be of interest to her.

Further assume that five months ago, Debbie purchased Epipens for Brad via an Internet website 21 (not shown in FIG. 3) when Brad became 4 years old. Debbie's purchase was recorded in primitive database 128. When rules executor process 121 of Debbie's IA 120 had its next regularly scheduled execution after the Epipen purchase, rules executor process 121 caused the terms “Epipen buyer” and “Mother of a Small Child” to be added to profile database 127 of Debbie's IA 120.

In this use case, three valuegram rules are created:
1. Marketer 10 of bee repellant creates a valuegram rule to display an ad to purchasers of Epipens.
2. Ad agency 18 representing a manufacturer of Epipens creates a valuegram rule to deliver a coupon for $20 off a next purchase of Epipens, to previous purchasers of Epipens.
3. The operator of website 20 creates a valuegram rule to receive notice when a site visitor is a mother of a small child, so that pictures displayed to the site visitor are suitable for viewing by children.

In this use case, Debbie starts a new browser session, and her browser goes to its default start page, the homepage for website 20. The three valuegram rules described above are triggered, so that Debbie receives a $20 coupon for Epipens via IA 201 or email, and her browser opens with a page from website 20 customized for a mother of a small child, the page displaying an ad for bee repellant. Advantageously, Debbie is immediately in a relevant environment and has the benefit of a $20 coupon. Website 20 is building loyalty from Debbie because it seems friendly to her as a mother of a small child. The bee repellant seller and the Epipen manufacturer have easily reached a relevant potential customer, Debbie.

As the first active action in her browser session, Debbie types a new search keyword into her browser toolbar to browse the dictionary in host 100, and she is taken to a pertinent portion of the dictionary. Subsequent actions taken by Debbie during her browsing session are outside the scope of this use case.

Later that day, host 100 generates an interesting website suggestion for Debbie and provides it to her.

The operation of host 100 is now described in connection with the above-discussed use case.

FIG. 5A-5C are a flowchart showing what happens at the start of a user's new browser session, when the user's intelligent assistant answers questions about its user without divulging the identity of its user.

At step 1000 of FIG. 5A, ad agency 18 representing the manufacturer of Epipens defines a valuegram lead generation rule shown in Table 2 using business interface 300, and sends the rule to VIM 140. The rule states that if a user who is an “Epipen buyer” starts a new browser session, then an email should be delivered to the user's email address providing a $20 off coupon. In other embodiments, the rule states that a message should be provided to IA 201 to display in a pop-up window to the user.

TABLE 2

| | |
|---|---|
| Rule ID: | VG Rule LeadGen-16789 |
| Rule Author: | Ad agency 18 |
| Rule Trigger: | User = “Epipen buyer” |
| Notice to: | Lead generation process 131 |
| Rule Action: | Send email text |
| | “Until the end of the month, get $20 off your next |
| | purchase of a box of XYZ Epipens at www.amazon.com, |
| | enter coupon code XYZ20 at checkout” |
| Destination: | email address of User |
| ActionPrice: | $5 |
| Expiration: | Earlier of (after delivery to 1000 users) and |
| | (end of current month) |

At step 1005, VIM server interface 140 receives the new rule, stores it in VIM database 143, and registers the notice condition and notice destination in the rule with host interface 150.

At step 1001 of FIG. 5B, marketer 10 of bee repellant defines a valuegram ad generation rule shown in Table 3 using business interface 300, and sends the rule to VIM 140. Assume that ad server 18 has an ads database (not shown) including an ad having identifier “Ad-ID-98765” that is a banner ad showing an Epipen injecting an arm that has received a bee sting. The rule states that if a user who is an “Epipen buyer” starts a new browser session, then a message should be sent to ad server 18 including the ad code “Ad-ID-98765”, the website address in the notice of a new browser session, and the session ID provided in the notice of a new browser session.

TABLE 3

| | |
|---|---|
| Rule ID: | VG Rule AdGen-20202 |
| Rule Author: | Marketer 10 |
| Ad Size: | Banner-2 |
| Rule Trigger: | User = “Epipen buyer” |
| Notice to: | Ad generation process 132 |
| Rule Action: | Message = (ad = “Ad-ID-98765” |
| | and address = “User Session Address” |
| | and sessionID = “User SessionID”) |
| Destination: | Ad Server 18 |
| ActionPrice: | $0.20 |
| Expiration: | (after delivery to 20,000 users) |

At step 1006, VIM server interface 140 receives the new rule, stores it in VIM database 143, and registers the notice condition and notice destination in the rule with host interface 150.

At step 1002 of FIG. 5C, an administrator named Chris for website 20 defines a publisher valuegram rule shown in Table 4 using business interface 300, and sends the rule to VIM 140. The rule states that if a user who is a “Mother of a Small Child” arrives at website 20, then host 100 should send code “31117” to website 20.

TABLE 4

| | |
|---|---|
| Rule ID: | VG Rule PubGen-35503 |
| Rule Author: | Chris@Website 20 |
| Rule Trigger: | ((new site visitor at website 20) and |
| | (User = “Mother of a Small Child”)) |
| Notice to: | Publisher VG Generator Process 133 |
| Rule Action: | Message = (code = “31117” |
| | and sessionID = “User SessionID”) |
| Destination: | Website 20 |
| ActionPrice: | none |
| Expiration: | none |

At step 1007, VIM server interface 140 receives the new rule, stores it in VIM database 143, and registers the notice condition and notice destination in the rule with host interface 150.

Steps 1010 and 1015 occur once, and are depicted in each of FIGS. 5A-5C to show how these steps relate to the rest of the processing shown in these flowcharts.

At step 1010, user 30, Debbie, begins a new browser session, such as by activating her browser having a start page set to the homepage for website 20. IA 201 notices the new session and sends a new session notification including a session ID request to IA 120. At step 1015, IA 120 receives the new session notification, stores the new session notification in primitive database 128, and sends the new session notification for user 30 to host interface 150 (not shown). The reception and sending are performed by general parts of IA 120, not specifically shown as separate processes in FIG. 3.

Session manager 151 of host 150 receives the new session notification, creates a new session ID such as “IA201-0843”, and updates its current sessions table (not shown) to include an entry for session “IA201-0843” and user “user 30”. Since the action is a new session, session manager 151 checks its notice table, and finds each of lead generation process 131, ad generation process 132 and publisher VG generation process 133 should be notified. Session manager 151 returns the session ID to IA 120 which in turn sends the session ID to IA 201. Primitive database 128 is updated with the session ID for the new session as shown in Table 5.

TABLE 5

| | |
|---|---|
| Action: | New session |
| SessionID: | IA201-0843 |
| Address: | www.website20.com |
| Timestamp: | 2008 December 15 08:43 |
| Origination: | Server 863 session 52467 at AOL server farm |

Session manager 151 sends a notice as shown in Table 6 (a subset of Table 5) to each of lead generation process 131, ad generation process 132 and publisher VG generation process 133.

TABLE 6

| | |
|---|---|
| Action: | New session |
| SessionID: | IA201-0843 |
| Address: | www.website20.com |

At step 1020 of FIG. 5A, lead generation process 131 receives the new session notice shown in Table 6.

At step 1025, lead generation process 131 sends a valuegram request to VIM 140, as shown, for example, in Table 7.

TABLE 7

| | |
|---|---|
| RequestID: | 12233 |
| Requestor: | Lead gen 133 |
| VG type: | Lead generation |
| SessionID: | IA201-0843 |
| Address: | www.website20.com |

At step 1030, VG generator 142 of VIM 140 extracts the type of valuegram to generate from the valuegram request, namely, type lead generation.

At step 1040, VG generator 142 reads VIM database 143 by type to get all valuegram generation rules relating to lead generation. VG generator 142 extracts the trigger conditions from the retrieved valuegram rules.

At step 1045, VG generator 142 requests profile information corresponding to the trigger conditions for the user corresponding to session ID IA201-0843 from IA 120.

At step 1050, IA 120 consults host interface 150 to determine which user corresponds to session ID IA201-0843. Host interface 150, specifically, session manager 151, replies that user 30 is the correct user. IA 120 then forwards the profile request to profile inquiry process.

At step 1055, profile inquiry process 122 checks whether information relating to the trigger conditions can be provided based on permission set by user 30. Profile inquiry process 122 gets the permitted data from profile database 127, and returns it to VG generator 142.

At step 1060, VG generator 142 receives the permitted profile information for the user corresponding to the session ID in the valuegram generation request.

At step 1065, VG generator 142 generates a valuegram by using the permitted profile information to determine which rules have their trigger conditions met, and for the triggered rules, creating a valuegram as shown in FIG. 4A. VG generator 142 returns the valuegram to lead generation process 131.

At step 1070, lead generation process 131 receives the valuegram.

At step 1075, lead generation process 131 delivers the valuegram to host interface 150 for forwarding to the intelligent assistant corresponding to the session ID in the valuegram generation request. Session manager 151 of host interface 150 determines that IA 120 for user 30 is the correct process, and forwards the valuegram to IA 120.

At step 1085, IA 120 receives the valuegram and checks its delivery rules. For example, let it be assumed that profile database 127 for user 30 specifies that user 30 is willing to receive up to two offers per browsing session. Applying this preference to the valuegram of FIG. 4A, IA 120 keeps the first two rows and deletes the third row. That is, the owner of the third valuegram rule did not pay enough to have its offer delivered to user 30, because the owners of the first two rules were willing to pay more. It will be appreciated that offer delivery varies based on user preferences and how much the rule owners are willing to pay. In some embodiments, user preference is indicated based on interest level, for example, a user specifies that they are willing to receive all offers for words in which their interest level is above a threshold value.

IA 120 delivers the first offer as follows. The valuegram rule VG Rule LeadGen-16789 in Table 2 specifies that the $20 offer should be delivered in an email, so IA 120 sends a corresponding offer email to the email address for user 30 specified in profile database 127. IA 120 reports this action to host interface 150, and accounting process 153 adds a charge of $5 to the invoice in accounting database 154 for ad agency 18, the owner of the valuegram rule, corresponding to delivery of the $20 coupon to user 30. IA 120 also records this action in primitive database 128.

IA 120 delivers the second offer as follows. Assume the valuegram rule corresponding to the second offer (not shown) specifies that the $10 offer should be delivered as a pop-up window having a hyperlink that the user clicks on to accept the offer and purchase the item at a reduced price. IA 120 sends the pop-up window to the origination location in the new session notification of Table 5. IA 120 reports this action to host interface 150, and accounting process 153 adds a charge of $2 to the invoice in accounting database 154 for the valuegram rule owner, corresponding to delivery of the $10 coupon to user 30. IA 120 also records this action in primitive database 128.

If user 30, Debbie, responds to the email with the $20 coupon, or the pop-up window with the $10 coupon, the response is captured by IA 201 and reported to IA 120 for storage in primitive database 128. In some cases, IA 120 reports the response to host interface 150 so that accounting database 154 can be updated by accounting process 153.

At step 1021 of FIG. 5B, ad generation process 132 receives the new session notice shown in Table 6.

Step 1026 is similar to step 1025 of FIG. 5A, but as step 1026, process 132 also asks VIM 140 for information relating to the quantity of ads and what type of ads are accepted by website 20 for the webpage that the user is visiting. Via business interface 300, this information was stored in VIM database 143 by the publisher of website 20 or the ad provider for website 20.

Step 1031 is similar to step 1030 of FIG. 5A, but at step 1031, VIM 140 gets only ad valuegram generation rules relating to the type(s) of ads that can be displayed on the webpage that the user is visiting.

Steps 1046, 1051, 1056, 1061, and 1066 of FIG. 5B generally respectively correspond to steps 1045, 1050, 1055, 1060, and 1065 of FIG. 5A and are not discussed here for brevity.

At step 1071, ad generation process 132 receives the valuegram shown in FIG. 4B and the ad quantity and type information.

At step 1076, ad generation process 132consults the ad quantity information provided by VIM 140 to determine that only one ad can be displayed on the webpage that Debbie is visiting. So, ad generation process 132 keeps only the first row of the valuegram shown in FIG. 4B, and deletes the other rows. According to VG Rule AdGen-20202 shown in Table 3, the desired action is to send a message to ad server 18. Ad generation process 132 sends the specified message to ad server 18, and reports this action to host interface 150, so that accounting process 153 adds a charge of $0.20 to the invoice in accounting database 154 for the valuegram rule owner, corresponding to delivery of the ad to user 30. IA 201 reports receipt of the ad to IA 120 for recording in primitive database 128.

At step 1086, ad agency 16 receives the message specified in VG Rule AdGen-20202 and reacts accordingly.

At step 1022 of FIG. 5C, publisher valuegram generator process 133 receives the new session notice shown in Table 6.

Steps 1027, 1032, 1047, 1052, 1057, 1062, and 1067 of FIG. 5C generally respectively correspond to steps 1025, 1030, 1045, 1050, 1055, 1060, and 1065 of FIG. 5A and are not discussed here for brevity.

At step 1072, publisher valuegram generator process 133 receives the valuegram shown in FIG. 4C, including the message for VG Rule PubGen-35503 shown in Table 4. Assume that VG Rule PubGen-35504 (not shown) states that if a user who is a “Female” arrives at website 20, then host 100 should send a message to website 20 consisting of (i) code “31152” and (ii) the session ID for the newly arrived user.

At step 1076, publisher valuegram generator process 133 sends the messages specified in VG Rule PubGen-35503 and VG Rule PubGen-35504 to website 20.

At step 1087, website 20 receives the messages specified in VG Rule PubGen-35503 and VG Rule PubGen-35504 and reacts accordingly.

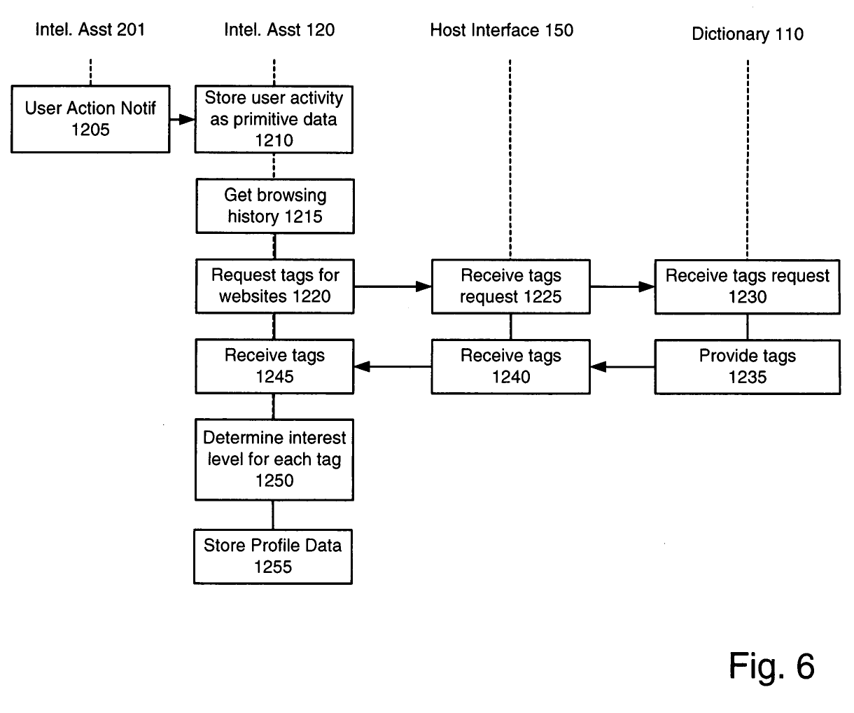

FIG. 6 is a flowchart showing how an intelligent assistant learns about its user. More specifically, FIG. 6 shows how a user's web browsing activity is converted into information about the user's interests.

At step 1205, user 30, Debbie, enters a webpage address, a universal resource locator (URL), in her browser. Assume that Debbie first visited this webpage one day previously. IA 201 notices the action and sends a notice of the action containing the URL that user 30 has requested and a timestamp to IA 120.

At step 1210, IA 120 receives the URL and timestamp from IA 201. IA 120 stores the URL and timestamp as a primitive data element in primitive database 128 for user 30.

At step 1215, which typically occurs sometime later such as in response to a daily timer, interest calculation process 124 of IA 120 gets the browsing activity for user 30 from primitive database 128.

At step 1220, interest calculation process 124 sends a request to host interface 150 for tags and webpage predictability quality scores (PQS) for all webpages visited by user 30. In some embodiments, only tags for webpages visited since the previous execution of interest calculation process 124 are requested.

At step 1225, tag extractor process 152 of host interface 150 receives the request from interest calculation process 124, and sends a corresponding lookup request to site tags database 117.

At step 1230, site tags database 117 of dictionary 110 receives the lookup request from tag extractor process 152. Since Debbie visited the same webpage yesterday, site tags database 117 is populated. It will be recalled that database 117 is populated by tag extractor 152 when the webpage is first visited, generally with tags selected by tag extractor 152 in response to keywords for the webpage provided by site keyword extractor 99.

At step 1235, site tags database 117 retrieves the tags and PQS for the webpages in the request, and sends this information to tag extractor process 152.

At step 1240, tag extractor process 152 receives the requested information and forwards it to interest calculation process 124.

At step 1245, interest calculation process 124 receives the tags and webpage predictability quality scores (PQS) for all webpages visited by user 30.

At step 1250, interest calculation process 124 determines the interest level for each tag. Recall that one method for determining interest level is simply to add up the number of times that information corresponding to a tag has been viewed by the user in a predetermined time period. Another method is to weight each viewing by the PQS associated with the viewing, and then add the weighted viewing counts. Other methods will be apparent to those of ordinary skill.

At step 1255, IA 120 stores the tag and newly calculated interest level in profile database 127.

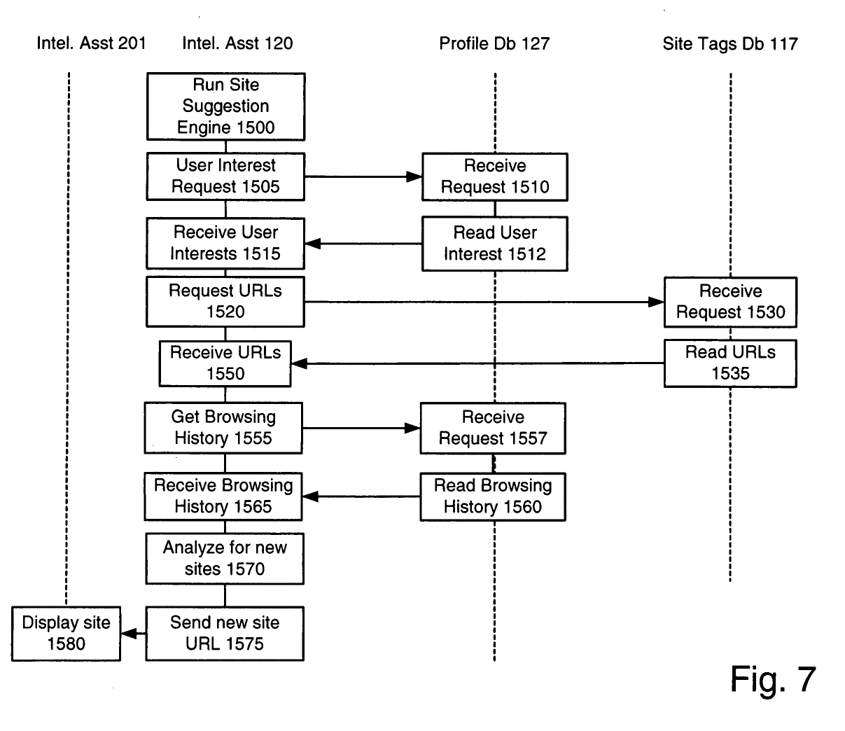

FIG. 7 is a flowchart showing how an intelligent assistant determines an action it should take.

Assume that recently, Debbie has viewed several articles about bee sting allergies. IA 201 has reported this activity to IA 120, and IA 120 added the website addresses for the articles to Debbie's browsing history table in profile database 127. Many of these added website addresses contain the keywords “bee” and “allergy”. During the most recent execution of interest calculation process 124, Debbie's recent browsing activity resulted in the words “bee” and “allergy” receiving an interest ranking of “8” from process 124, and these high interest rankings were stored by process 124 in the attribute table of profile database 127, as shown in Table 8. Debbie has not explicitly set her interest in these words.

TABLE 8

| | |
|---|---|
| dic-type: | word |
| term: | bee |
| calc-interest: | 8 |
| user-set-interest: | — |
| . . . | |
| dic-type: | word |
| term: | allergy |
| calc-interest: | 8 |
| user-set-interest: | — |

Assume that Debbie's profile database 127 also includes settings for what she considers to be a high interest threshold and a low interest threshold, as shown in Table 9.

TABLE 9

| | |
|---|---|
| interest-threshold-high: | 7 |
| interest-threshold-low: | 3 |

At step 1500, at a predetermined time, site suggestion process 123 of IA 120 executes.

At step 1505, site suggestion process 123 prepares a user interest request for user 30 and sends it to profile database 127.

At step 1510, profile database 127 receives the user interest request.

At step 1512, profile database 127 reads the interests and interest thresholds for the user, and returns them to site suggestion process 123.

At step 1515, site suggestion process 123 receives the user interests and thresholds, as shown in Tables 8 and 9.

At step 1520, site suggestion process 123 requests URLs corresponding to the user interests having an interest level that equals or exceeds the high interest threshold from site tags database 117.

At step 1530, site tags database 117 receives the URL request.

At step 1535, site tags database 117 reads the URLs corresponding to the user interests, and returns the URLs to site suggestion process 123.

At step 1550, site suggestion process 123 of IA 120 receives the URLs and ranks them according to user interests. In one embodiment, the ranking occurs by simply counting the number of keywords for the site. For example, a site having a keyword of “bees” gets a ranking of “1”, while a site having keywords “bees” and “allergy” gets a ranking of “2”.

At step 1555, site suggestion process 123 requests the browsing history for user 30 from profile database 127.

At step 1557, profile database 127 receives the browsing history request.

At step 1560, profile database 127 retrieves the browsing history for user 30 and returns it to site suggestion process 123.

At step 1565, site suggestion process 123 receives the browsing history for user 30.

At step 1570, site suggestion process 123 compares the ranked URLs received at step 1550 with the URLs in the browsing history to determine if there are any new URLs received at step 1550. If not, site suggestion process terminates.

At step 1575, if there are new URLs received at step 1550, then site suggestion process 123 selects the top ranked of the new URLs and sends it to IA 201. Since Debbie has been recently browsing articles about bee sting allergies, the recommended site probably is also related to bee sting allergies.

At step 1580, IA 201 receives the new URL and displays a message with the new URL to user 30.

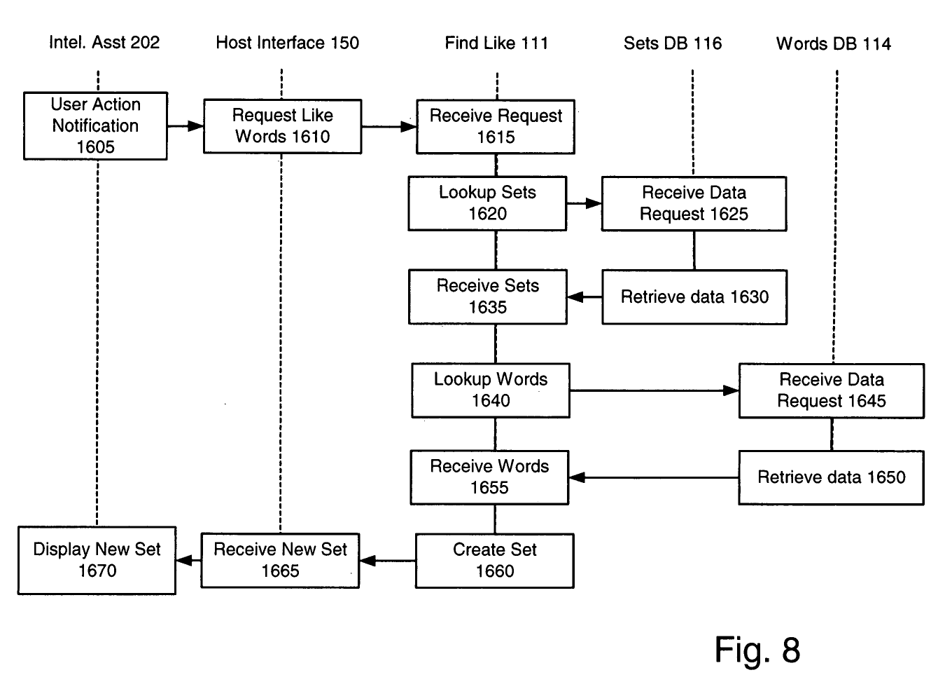

FIG. 8 is a flowchart showing operation of find like process 111.

Assume that user 30 has been in the habit of backing up their personal computer to external storage, in this case, a disk drive that connects to the computer via a USB port. The disk drive has its own power supply. The disk drive is old, so user 30 believes there is probably newer better technology, and wishes to find replace the old external disk drive. However, user 30 is not sure what the latest names for suitable technology are. So, user 30 uses the screen interface of IA 202 to enter the words “external disk drive” and selects the “Find Like” function, such as by clicking on a button displayed on the screen interface of IA 202.

At step 1605, IA 202 provides a notice to host interface 150 that user 30 has chosen one or more words and selected “Find like” via a screen interface provided by IA 202.

At step 1610, host interface 150 forwards the word(s) selected by user 30 to find like process 111 of dictionary 110.

At step 1615, find like process 111 receives the selected word(s).

At step 1620, find like process 111 searches sets database 116 for sets which contain the selected word(s).

At step 1625, sets database 116 receives the search request from find like process 111.

At step 1630, sets database 116 retrieves sets of words including the selected word(s), and provides these sets to find like process 111. In this example, assume that the sets shown in Table 10 are returned.

TABLE 10

| Set Name | Set Contents |
|---|---|
| Brad's Gifts for Geeks | external disk drive |
| | flash memory |
| | jump drive |
| | USB portable disk drive |
| | USB camera |
| | cordless mouse |
| Portable storage devices | flash memory |
| | jump drive |
| | USB drive |
| | mini drive |
| | external disk drive |
| | camera chip |
| Personal computer peripherals | keyboard |
| | mouse |
| | display |
| | flat panel |
| | external disk drive |
| | memory stick |
| | camera |
| Debbie's puter wish list | 4 GB memory stick |
| | 500 GB portable disk drive |
| | external disk drive |

At step 1635, find like process 111 receives the retrieved sets having the selected word(s).

At step 1640, find like process 111 determines which words in the retrieved sets are new, that is, different than the selected word(s). Find like process 111 then searches words database 114 for the newly found words. Table 11 shows the newly found words.

TABLE 11

flash memory
jump drive
USB portable disk drive
USB camera
cordless mouse
USB drive
mini drive
camera chip
keyboard
mouse
display
flat panel
memory stick
camera
4 GB memory stick
500 GB portable disk drive

At step 1645, words database 114 receives the search request from find like process 111.

At step 1650, words database 114 retrieves words that are synonymous with the newly found words, and sends the synonymous words to find like process 111. Table 12 shows the retrieved synonyms.

TABLE 12

| Word | Synonymous Words |
|---|---|
| flash memory | external memory |
| | external storage |
| | portable storage |
| | memory stick |
| jump drive | external disk drive |
| | external storage |
| | USB disk drive |
| | portable disk drive |
| USB portable disk drive | external disk drive |
| | external storage |
| USB camera | external camera |
| cordless mouse | wireless mouse |
| | pointing device |
| USB drive | external disk drive |
| | external storage |
| mini drive | external disk drive |
| | portable disk drive |
| | portable storage |
| camera chip | external memory |
| keyboard | typing pad |
| | touch screen |
| mouse | pointing device |
| display | cathode ray tube |
| | flat panel |
| | monitor |
| flat panel | display |
| | monitor |
| memory stick | external storage |
| | flash memory |
| camera | video recorder |
| 4 GB memory stick | external storage |
| | flash memory |
| 500 GB portable disk drive | external disk drive |
| | external storage |
| | USB disk drive |

At step 1655, find like process 111 receives the synonymous words.

At step 1660, find like process 111 creates a new set comprising the selected word(s), the newly found words and the synonymous words. Find like process sorts the newly created set according to the number of times each word occurs in the new set, thereby creating a new sorted set. Find like process 111 sends the new sorted set to host interface 150. Table 13 shows the new sorted set; the numbers represent number of times the term is in the set.

TABLE 13

external storage 6
external disk drive 4
flash memory 3
external memory 2
portable storage 2
memory stick 2
display 2
flat panel 2
monitor 2
USB drive
portable disk drive
jump drive
USB portable disk drive
mini drive
USB camera
external camera
cordless mouse
wireless mouse
pointing device
camera chip
typing pad
touch screen
keyboard
pointing device
mouse
cathode ray tube
camera
video recorder
4 GB memory stick
USB disk drive
500 GB portable disk drive

At step 1665, host interface 150 forwards the new sorted set to IA 202.

At step 1670, IA 202 presents the new sorted set to user 30.

User 30 sees that “external disk drive” is probably similar to “flash memory”, “external memory”, “portable storage” and “memory stick”. User 30 now realizes that products are on the market that can meet user 30's storage needs without requiring a power cord.

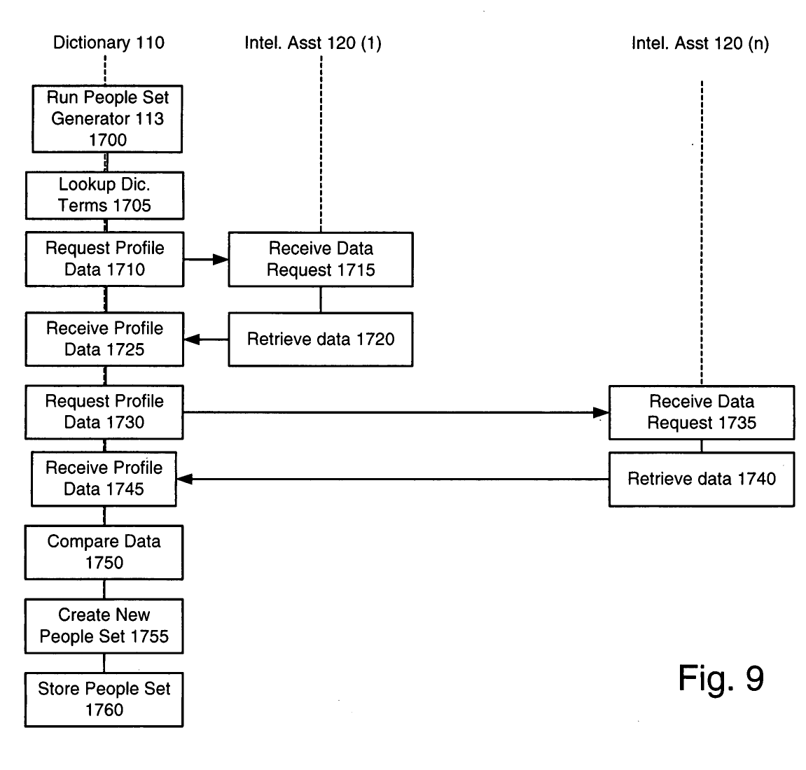

FIG. 9 is a flowchart showing operation of people set generator process 113.

At step 1700, dictionary 110 activates people set generator 113, such as on a time-driven or event-driven basis. For this example, assume that people set generator 113 was activated in response to an event of user 30 clicking on a “Find People Like Me” button on a screen interface provided by IA 202. IA 202 then provided user 30 with a list of words in their profile, sorted by interest level, and user 30 selected words.

At step 1705, people set generator 113 retrieves words from words database 114 synonymous with the words selected by user 30.

At step 1710, for each selected word and its retrieved synonyms, people set generator 113 requests its Interest Scale value from the first occurrence of IA 120, such as the occurrence belonging to user 31 (not shown).

At step 1715, IA 120 receives the request from people set generator 113.

At step 1720, profile inquiry process 122 of IA 120 reads the Interest Scale values for the selected and synonymous words from its version of profile database 127 and returns the values to people set generator 113. In some embodiments, IA 120 also reads information from its version of primitive database 128.

At step 1725, people set generator 113 receives user 31's Interest Scale values for the selected and synonymous words.

Steps 1710-1725 are repeated for each instance of IA 120, that is, for each user registered with host 100. Steps 1730-1745 correspond to steps 1710-1725, for the nth occurrence of IA 120.

At step 1750, people set generator 113 compares the retrieved interest values for each of the users with the interest values for user 30. When another user has the same words with an interest value similar to the interest value of user 30, then there is a match. In this example, an interest value is “similar” when it is the same or within one unit of another interest value.

At step 1755, people set generator 113 adds matches to new set of people like me for user 30.

At step 1760, people set generator 113 stores the new set in profile database 127. User 30 can now browse this set.

In an example of time-driven operation of people set generator 113, at a particular time, such as Sunday at 3 am, dictionary 110 executes people set generator 112 using all of the words in words database 114, and requiring exact matches. It will be understood that people set generator 113 thus mines the data in the various profile database 127 to find sets of users with interest levels that match in various words. This is useful information for marketers, as they may wish to customize their products or ad campaigns for such sets.

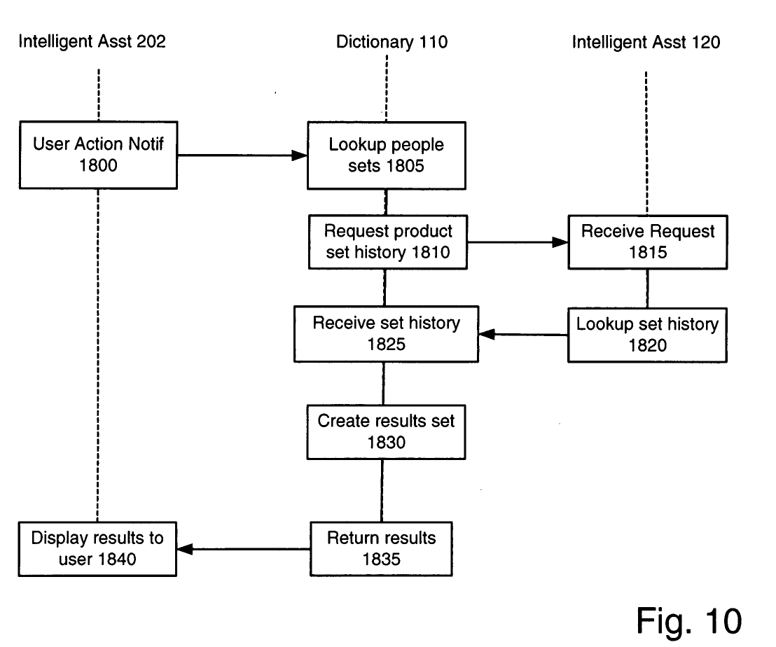

FIG. 10 is a flowchart showing how dictionary 110 customizes information.

Assume user 30 is looking at several product collections via a screen interface provided by IA 202, and clicks on a “People Like Me” button to see which collection other users prefer.

At step 1800, IA 202 sends to people set generator 113 the sets viewed by the user, and requests popularity information.

At step 1805, people set generator 113 searches in sets database 116 for “high match” people sets which this user is in. In this example, a “high match” people set is one that has 50 or more matches between the words in the profile of user 30 and the words in the profile of another use, with the words having a similar interest rating value, that is, an interest rating that is the same or within one unit of each other.

At step 1810, for each other user in each of the high match people sets, people set generator 113 requests from the user's IA 120 information as to whether a purchase was made using one of the product sets being viewed by user 30.

At step 1815, IA 120 for the first high match user receives the request and product sets list from people set generator 113.

At step 1820, profile inquiry process 122 of the first high match user's IA 120 retrieves the requested data from primitive database 128, and sends the results to people set generator 113.

At step 1825, people set generator 113 receives the results for the first high match user.

Steps 1810-1825 are repeated for each of the high match users.

At step 1830, people set generator 113 sorts the results and creates new set having as its elements which of the sets being viewed by user 30 was involved in a purchase made by users having profile data highly matching the profile data of user 30.

At step 1835, people set generator 113 sends the new set to IA 202.

At step 1840, IA 202 shows the new set to user 30.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method of reacting to a user based on characteristics of the user and without knowing the identity of the user, comprising:
obtaining the characteristics of the user based on a session ID associated with the user and without knowing the identity of the user,
comparing the obtained characteristics with at least one characteristic specified in at least one activity rule, each activity rule specifying at least one action, and
when the obtained characteristics match the specified characteristics in an activity rule, performing the action specified in the activity rule.
